(19) United States
(12) Patent Application Publication
(10) Pub. No.: US 2008/0288448 A1
(43) Pub. Date: Nov. 20, 2008

(54) METHOD, APPARATUS, AND SYSTEM FOR PROVIDING BUSINESS INTELLIGENCE

(76) Inventors: Justino Agredano, Pasadena, CA (US); Jay Armand Mitra, San Gabriel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/117,530

(22) Filed: May 8, 2008

Related U.S. Application Data
(60) Provisional application No. 60/917,885, filed on May 14, 2007.
(60) Provisional application No. 60/938,402, filed on May 16, 2007.

(51) Int. Cl. G06F 7/00

(52) U.S. Cl. 707/2

(57) ABSTRACT

The novel business intelligence system disclosed herein provides companies with an out of the box enterprise worthy business intelligence solution or environment. The business intelligence system encompasses all of the processes that are involved in the implementation of a business intelligence solution with maximum flexibility but minimizes the need for building a customized system

### CROSS-REFERENCE TO RELATED APPLICATIONS

The present application claims the benefit under 35. U.S.C. § 119(e) of U.S. Provisional Patent Application 60/917,885, titled METHOD, APPARATUS, AND SYSTEM FOR PROVIDING BUSINESS INTELLIGENCE and filed on May 14, 2007, and of U.S. Provisional Patent Application 60/938,402, titled METHOD, APPARATUS, AND SYSTEM FOR PROVIDING BUSINESS INTELLIGENCE and filed on May 16, 2007. The foregoing applications are hereby incorporated by reference in their entirety.

### BACKGROUND

1. Field

The embodiments herein disclosed generally relate to computer systems, and more particularly, relate to computer systems for developing business intelligence (BI) information and data useful or necessary for making business decisions.

2. Description of the Related Technology

Companies and business leaders face an increasingly competitive market place today. Accordingly, these business leaders must act quickly and decisively to ensure the success and survival of their organizations. To make effective decisions, leaders need data but often times such leaders are inundated by a deluge of data, much of which is not timely or relevant. Business intelligence solutions provide data and information in useful formats or just in time for business leaders to make intelligent and informed choices. The current model for business intelligence software is centered on the idea that the installation and use of business intelligence applications require a customized implementation.

### SUMMARY

In certain embodiments, the novel BI system disclosed herein provides companies with an out of the box enterprise worthy BI solution or environment with best of breed features. The BI system encompasses all of the processes that are involved in the implementation of a BI solution with maximum flexibility but minimizing the need for building a customized system. This means that businesses will spend 1/10th of the time installing and configuring the BI system than they would otherwise.

In certain embodiments, a business intelligence system comprises a database system, a data mart module, and a visualization module. In still other embodiments, the database system comprises pre-existing fact tables wherein the fact tables comprise a plurality of fact table elements and a plurality of relationships linking the fact tables and the plurality of fact table elements such that the user need not program fact tables and relationships between the fact tables; wherein the database system further comprises a wizard module configured to allow the user to match data elements from a plurality of data sources to the plurality of fact table elements in the fact tables; wherein the wizard module is further configured to establish relationships between the data elements from the plurality of data sources based on the plurality of relationships linking the fact tables and the plurality of fact table elements. In certain embodiments, the wizard module automatically or dynamically establishes relationships between the data elements from the plurality of data sources.

In certain embodiments of the business intelligence system, the data mart module comprises pre-established sets of summary level repositories, for example summary level tables, OLAP cubes, or the like. In certain embodiments, the data marts are created based on pre-existing rules or templates. In other embodiments, the visualization module comprises pre-established visual reporting tools (for example, reports, dashboards, scorecards, or the like), wherein the visualization module is configured to determine which visual reporting tools to use based on the pre-existing rules or templates applied to create the data marts such that the user need not specifically program the visualization module to visually display the reports.

For purposes of this summary, certain aspects, advantages, and novel features of the invention are described herein. It is to be understood that not necessarily all such aspects, advantages, and features may be employed and/or achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

The accompanying drawings, which are incorporated in and constitute a part of this specification, show examples of the several embodiments; however, other embodiments will be apparent to those of ordinary skill in the art from the drawing and the description, both of which serve to illustrate and not limit the several embodiments disclosed herein.

FIG. 1 is an illustration of all three components and their function.

FIG. 2 illustrates the configuration and administration portions of the use case scenarios outlined for the BI system.

FIG. 3 illustrates one embodiment of the installation wizard.

FIG. 4 illustrates another embodiment of the installation wizard wherein employee fields are matched.

FIG. 5 illustrates the process of matching fields from a data source, for example, InfoGenesis, to the ModelHouse Fct_RetailSales table.

FIG. 6 illustrates an example of the process for matching fields and the process for updating the Fct_RetailSales table.

### DETAILED DESCRIPTION OF THE EMBODIMENTS

Business intelligence relates to a broad category of applications and technologies for gathering, storing, analyzing, and providing access to data to help business leaders make better business decisions. BI related activities include but are not limited to, for example, the activities of decision support systems, statistical analysis, querying and reporting, online analytical processing (OLAP), forecasting, and data mining.

As used herein the term “database” is a broad term to refer to any type of database or database warehouse, and term is used interchangeably with the term “ModelHouse.” Additionally, the term “data mart module,” as used herein, is a broad term to refer to any set of summary level repositories, for example summary level tables, OLAP cubes, or the like, and term is used interchangeably with the term “ModelMart.” The term “visualization module” is also a broad term as used herein to refer to any type of system that displays the data using various visualization tools, for example, reports, dashboards, scorecards, or the like, and the term is used interchangeably with the term “ModelScape.”

The following chart explains certain aspects of one embodiment of the BI system:

| | BI System | |
|---|---|---|
| | | Average Time for |
| Process | User Steps | Implementation |
| Define data sources | Analysis current business | About 1 month |
| | applications and elements that | |
| | will be used in data warehouse | |
| Map data sources | Simple data entry and drag and | About 2 weeks |
| | drop table and field mapping | |
| Create data warehouse | Substantially no user steps | Substantially no time |
| Setup data marts and/or OLAP cubes | Substantially no user steps | Substantially no time |
| Create security | Assign rights to users. | Substantially no time |
| Create reports | Substantially no user steps | Substantially no time |
| Create executive dashboards, KPI's and | Substantially no user steps | Substantially no time |
| scorecards | | |
| Total Time for Implementation: | | About 1 Month 2 Weeks |

At least one underlining basis for the BI system is that data is the same or generally the same no matter its form, therefore it can be said that data is data. Under this principle we can arrive at a novel approach to the architecture of the BI system. This approach requires, in certain embodiments, that all containers for data be generic forms of the real world elements that they represent. The containers can then be used interchangeably to hold data from any source that has the same parameters as the container. The components have generic names and terms and their relationships and interactions are based on the idea that all data no matter what the label it may be given has the same properties when it comes to the relationships that it has with other data elements. In certain embodiments, the BI system allows users to import data from substantially any type of data storage system, for example, a Financial, Human Resources (HR), Employee Management, Point of Sale, or any other data storage system.

For example, most Human Resource systems contain information about employees regardless of who created the HR system, or how the system was architected, or how users interact with the system. In the end the data represents a company's employee population with supporting information about each of its employees. In certain embodiments, the BI system comprises a data repository that is configured to allow the user to match the data elements from the Human Resources system to the data elements of the data repository. In certain embodiments, the data repository is called the ModelHouse™. The data repository is capable of storing data from any data source.

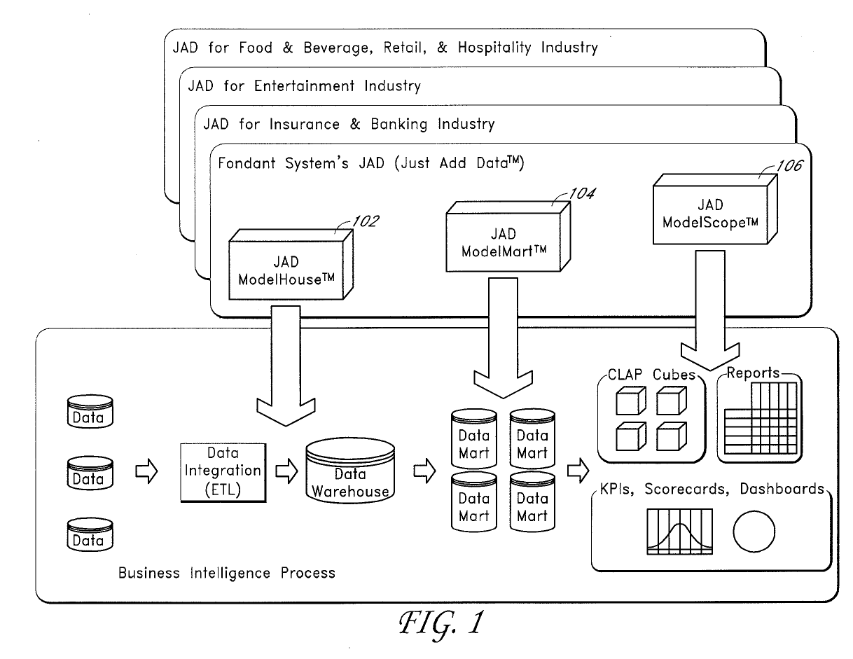

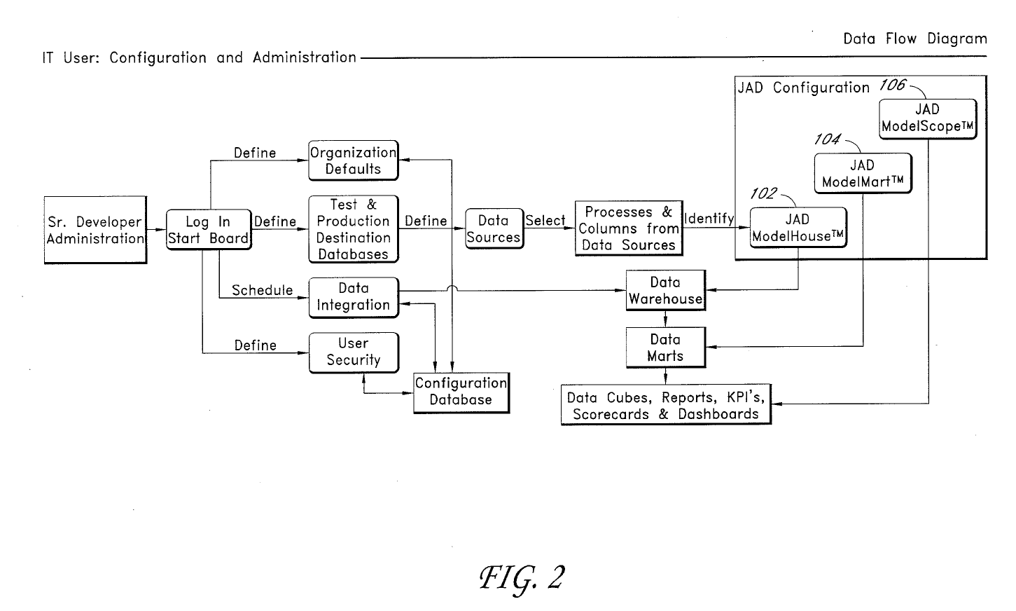

With reference to FIGS. 1 and 2, the BI system comprises, in certain embodiments, a database system (or a data warehouse module, and also called the ModelHouse™ Data Warehouse Module 102), a data mart module (also called the ModelMart™ Data Store Module 104), and a visualization module (also called the ModelScape™ Information Visualization Module 106). Each of the foregoing components can be used independently as a software tool and/or as part of an overall system or software package.

### ModelHouse™ Data Warehouse Module

The ModelHouse™ is a unique data store that accepts and stores data from any data source. This is made possible by allowing the user to match elements from the data source to elements in the ModelHouse™ of the BI system. The matching is done by first identifying what type of information is stored in a certain element of the data source then matching the element to the corresponding element in the ModelHouse™. This matching process is based on the idea that no matter what the name of the data source and its elements all electronic data is either an identifier of real world objects or an attribute of those objects. Accordingly, the BI system comprises a data warehouse that is created independently of the data that it will store. The ModelHouse™ departs from the current method by creating what we call real world placeholders for the data that it will store. Creating the BI system ModelHouse™ independent of the data that it will store means that the BI system ModelHouse™ has the following advantages:
1. Pre-made data warehouse.
2. Optimized data warehouse by creating indexes and relationships between tables and fields.
3. Extraction, Transformation and Load, ETL, rules.
4. If the data source changes for any reason;
   a. Upgrades to existing systems.
   b. Use of new modules of existing applications
   c. Replacement of applications
   d. Any other reason
      the ModelHouse™ easily adapts to the change by simply pointing to the new or changed data source. This allows for no interruption of data in the BI system ModelHouse™.

The foregoing table illustrates the ModelHouse™ in outline form:

The ModelHouse ™ is a unique data store with pre-built data
warehouse elements
Fact tables that represent transactional information for vertical markets.
As an example here are some fact tables for possible vertical markets:

| Fact Table | Market |
|---|---|
| Fct_RetailSales | Retail |
| Fct_FoodSales | Restaurants |
| Fct_Hospitality | Hospitality |
| Fct_Banking | Banking |

Each of these fact tables has fields for the transactional data elements of each respective vertical market. This allows the ModelHouse™ to be a complete data warehouse solution for any company in each of the vertical markets.

Dimension tables that represent supporting information
for vertical markets. As an example here are some dimension
tables for their vertical markets:

| Dimension Table | Market |
|---|---|
| Dim_employee | Retail |
| Dim_employee_labor | Retail |
| Dim_employee_jobs | Retail |
| Dim_product_groupings | Retail |
| Dim_product_accounting_groups | Retail |

ModelHouse™ uses these pre-built elements to create unique relationships between the fact and dimension tables.

The creation of the relationships is based on the key fields that are identified from the data source systems. The ModelHouse™ uses these key fields to create the necessary primary and foreign key relationships between the fact and dimension tables or where appropriate between fact and fact tables or dimension and dimension tables. The building of these relationships is key to the operation of the data warehouse. From these relationships indexes are created that optimize the data warehouse. The relationships are further used in the ModelMart™ module to create the necessary data marts.

In one embodiment, this relationship building process occurs wherein there is, for example, a retail sales system and a human resource system. In one example, the retail sales system is an InfoGenesis solution and the human resource system is a PeopleSoft® solution. In some embodiments, the retail sales system captures information about the sales transaction and a set of information about the employee who made the sales transaction. In certain embodiments, the human resource system captures information about the employee, wherein the human resource system is not connected to the sales system but rather they represent two separate data sources. The ModelHouse™ will use any matching information from both systems to create the necessary relationships between the two disparate systems to populate a sales fact table and an employee dimension table. This can be a social security number field or the employees first and last name. Using this information the ModelHouse™ will create unique primary and foreign keys between the fact and dimension tables.

In this embodiment, the retail sales system contains all the transactional sales information for a company, and the human resource system contains records about the employees, for example, date of hire, years of experience, educational level, training courses attended, or the like. At least one objective of the ModelHouse system and the relationship building process is to link the sales information from retail sales system to the employee information in the human resource system. As such, a company is able to use the BI system to generate reports that provide information regarding, for example, sales by years of experience. Without the BI system, the retail sales system alone does not contain the necessary information about the employees to generate a report showing sales by years of experience.

As mentioned previously, the BI system requires no or substantially no customization, and only minimal setup. In one embodiment, the setup process requires that the user identify the source systems, for example, the InfoGenesis and PeopleSoft® system that are in use by the company. In one embodiment, the user uses an installation wizard that prompts the user to identify the source systems and their location on the network such that the BI system can access and use the data in those source systems. Once the source systems are identified, the BI system will review them to determine what data fields are being stored in the source systems. In some embodiments, the BI system will automatically match the data fields in the first source system to the common data fields in the second source system. To automatically match the data field, the BI system analyzes the data fields to determine if certain data fields possess the same name. In other embodiments, the BI system is configured to automatically match data fields by searching for common data entries that exist in both source systems. For example, if the BI system determines that the numbers stored under the “SSN” data field of the retail sales system also exist or substantially exist under the “National_ID” data field of the human resource system, then the BI system will automatically establish a linkage or data relationship between the two data fields.

In other embodiments, the installation wizard will display the data elements from each source system wherein the user only clicks and drags one data element from the first source system to the common data element in the second source system. In the example illustrated below, the InfoGenesis system and the PeopleSoft® system both contain social security information of each employee, however, the data fields are named differently. The user simply clicks and drags the “National_ID” field in the PeopleSoft® system over the “SSN” field in InfoGenesis system. In this example, the ModelHouse module understands that these two fields are used to link the PeopleSoft® system to the InfoGenesis system, such that the information in the two systems can be combined and analyzed.

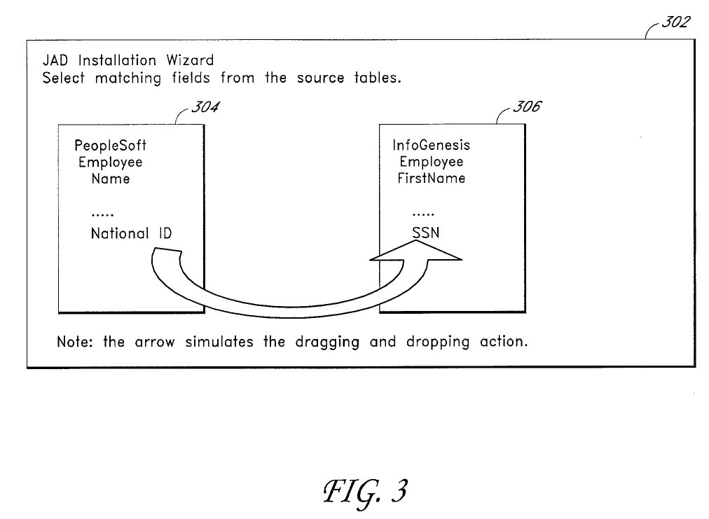

Referring to FIG. 3, in an embodiment, the ModelHouse module does not contain the Employee table within the PeopleSoft® system or the Employee table of the InfoGensis system, and the BI system does not know what type of information is stored in each source system. Accordingly, the installation wizard 302 then prompts the user to select the type of information that each of the two source systems contains. In one example, the user selects “HR data” for the human resource system and “Sales information” for the retail sales system. By selecting the type of information stored in each of the systems, the ModelHouse module is able to identify where the data from each of the systems will be stored. In the example above, the employee data goes into what is called the employee dimension table, or Dim_Employee, and the sales information will go to the Fct_RetailSales table. At this point in the setup process the ModelHouse module knows where the source information is located, how to link that information and where that information will be stored internally.

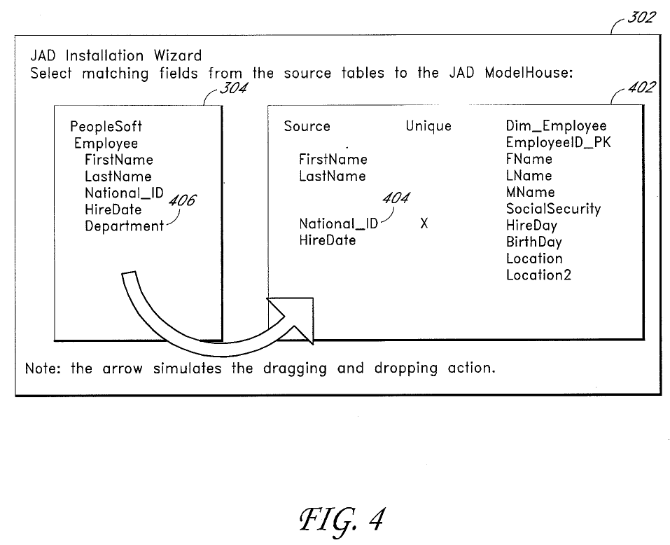

With reference to FIG. 3, in an embodiment, the fields from the PeopleSoft® system 304 are then matched to the Dim_Employee table and the fields from InfoGenesis 306 to the Fct_RetailSales table. In an embodiment, this is also accomplished by dragging and dropping the fields from one location to another. Referring to FIG. 3, this is illustrated by showing the drag and drop process of matching the employee fields from the PeopleSoft® data source to the Dim®Employee table in JAD. In the illustration the user has already clicked and dragged over the FirstName and LastName fields from PeopleSoft® over to the Dim_Employee table. As the fields from PeolpeSoft are dragged over their corresponding fields in the Dim_Employee table their names are added to the Source column. Referring to FIG. 4, as the user selects the fields he will also select which field from the PeopleSoft® system contains the unique identifier for each record. This field is identified in our wizard by providing a column named Unique 402 and a check box for that column that can be checked to identify the field. In this example, the field is the National_ID field 404. In the example the unique identifier is one field but the system can contain a combination of fields to identify each unique record like the first name field and the last name field.

Referring to FIG. 4, the field names in the PeopleSoft® system and the Dim_Employee table do not match. Accordingly, in this example, the user needs to know that the field named Fname in the Dim_Employee table is designed to hold the employee first name and that the FirstName field in the PeopleSoft® system contains the first name. The user also needs to know that although there is no field that closely resembles the word Department 406 in the Dim_Employee table as there is in the PeopleSoft® system that the Location field in the Dim_Employee table is designed to contain the functional area where an employee is assigned to. This allows for the source system to be compatible with any of the numerous human resource systems that are in the market now or that will be developed in the future. In this example the system is configured to accept data from any source system should the company decide to use a new human resource system, such as the SAP human resource system. In certain embodiments, the user can start the installation wizard outlined above and using the drag and drop function they can quickly and easily change the source of employee information and not disrupt the flow of information into the ModelHouse module.

In certain embodiments, the next step in the ModelHouse module is the assigning of a unique id to every employee record in the Dim_Employee table. In one example, this process is accomplished in two distinct steps. The first step is to load the employee records from PeopleSoft® to the Dim_Employee table and assigning a unique id to each one of those records. During the load process the ModelHouse will match the records from PeopleSoft® with the records in the Dim_Employee table using the National_ID field in PeopleSoft® with the SocialSecurity field in the ModelHouse. The National_ID field is used because during the setup process it was selected as the unique field. If the record exists in the Dim_Employee table then certain steps can be performed and may include but will not be limited to updating the existing records in the Dim_Employee table with the values in the Human Resource system. If the record does not exist then the system will add the record to the Dim_Employee table and will assign a unique numeric value to that record in the tables Primary Key identified as EmployeeID_PK in FIG. 2. In this manner all records from the PeopleSoft® source system will be added and synchronized with the Dim_Employee table in the ModelHouse.

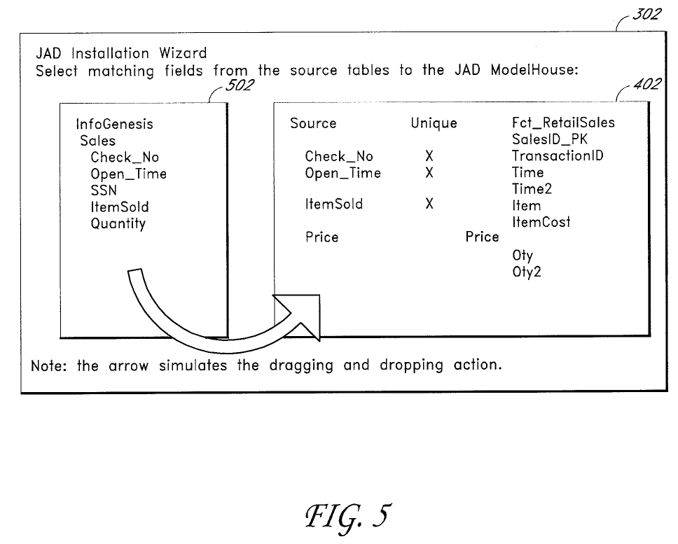

With reference to FIG. 5, the same process that was outlined above is also performed for identifying where the information from the InfoGenesis sales system 502 will be loaded into the ModelHouse. As discussed above the user will have already identified that the InfoGenesis system 502 contains sales information. FIG. 5 illustrates how the process would be followed in matching fields from InfoGenesis to the ModelHouse Fct_RetailSales table. During the same process the unique field or fields that identify the sales data in InfoGenesis will also be identified using the Unique column 402.

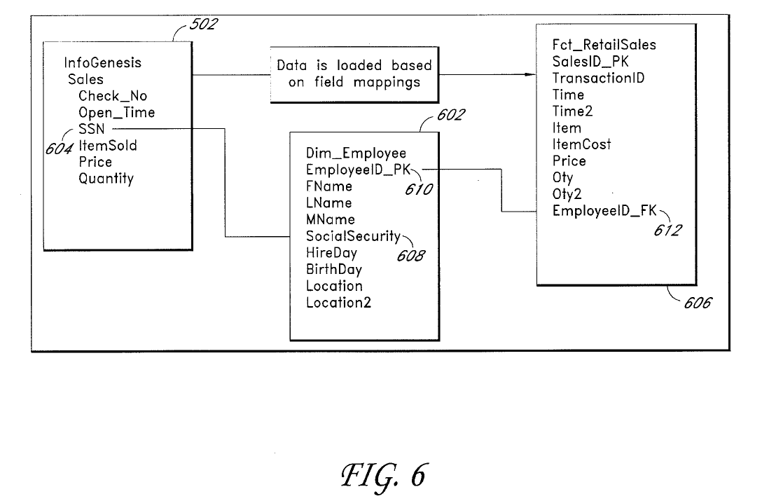

With reference to FIG. 6, one of the main difference between the foregoing process for the InfoGenesis system 502 and the PeopleSoft® system 304 is that the SSN field 604 in the InfoGenesis table 502 will not be matched to a field in the Fct_RetailSales table 606. The reason for this is that the ModelHouse system will automatically add the matching value. At this point during the load process employee data has been loaded from the PeopleSoft® human resource system to the ModelHouse Dim_Employee table 602. That employee information is now synchronized and the ModelHouse has created a unique id for every record in the Dim_Employee table 602. Now the sales data from the InfoGenesis system will be added to the Fct_RetailSales table 606 as outlined above. Missing from the Fct_RetailSales table 606 is a way to link that data to the Dim_Employee table 602. The ModelHouse will determine who that employee is by matching the records from the InfoGenesis sales data to the Dim_Employee table 602 using the SSN field 604 and the Social_Security field 608 in each table respectively. In this fashion the BI system can add the value in the EmployeeID_PK field 610 to the EmployeeID_FK field 612 in the Fct_RetailSales table 606. FIG. 6 illustrates, for example, the matching of fields and how the Fct_RetailSales table 606 is updated.

The example set forth above only describes two types of data sources but the ModelHouse can have a large number of fact tables like the Fct_RetailSales and a large number of dimension tables like the Dim_Employee table. And the relationship building process is performed in the same manner for any other dimension table that is added. So that if a company decided to add information from their accounting system to the ModelHouse a similar process would be performed where the source data would be identified and matched against ModelHouses's accounting information. And in similar fashion the relationship between the sales data and the accounting data would be performed allowing the ModelHouse to create a unique id for accounting data and the reciprocating foreign key for the sales data in the Fct_RetailSales table.

### ModelMart™ Data Store Module

The ModelMart™, is a series of summary information data stores. The basis for ModelMart™ is the idea that all summary information that will ever be needed from a data warehouse can be created based on rules and a top down approach. The top down approach begins with the dimensions in a data warehouse. Each field in a dimension table represents an identifier for the information that is stored in the fact table. Therefore each element in the dimension table can be used to summarize the data in the fact table. At its highest level that summarization will be a total value for each field in the fact table for all of the records grouped by the field in the dimension table. This level is known as level one summarization. The next level of summarization is done at each level by date, this summary level is known as level point 2. For the highest level possible for each dimension the summarization by date is therefore known as level 1.2. Level 1.2 by default is a summarization by a single day. The date level summarization continues in further sub levels to represent further date-time groupings such as hour, week, month, quarter, and\or year. Thus a summarization by hour for a dimension is identified as level 1.2.1. This grouping and sub-grouping of summarization levels provides a basis on which to build summarization values for all dimension values and the corresponding data values in the fact table. As an example here is a top level approach to a fact table that stores sales data and is being summarized by the location level.

| Fact Table | Dimension Table |
|---|---|
| Fct_RetailSales | Dim_Location1 |

The location table includes but is not limited to a grouping of regions. The Fact table stores transaction level information by store. In this scenario the ModelMart™ would contain templates and rules for each summarization level.

Level 1

| Fct_RetailSales.Sales | Dim_Location1.Region |
|---|---|
| $13,402.45 | East |
| $10,323.25 | West |

Level 2

| Fct_RetailSales.Date | Fct_RetailSales.Sales | Dim_Location1.Region |
|---|---|---|
| Sep. 23, 2002 | $3624.65 | East |
| Sep. 24, 2002 | $4852.35 | East |
| Sep. 25, 2002 | $4925.45 | East |

After the summarization levels are established templates with rules governing those templates are used to correctly group and summarize the information in the data warehouse.

The templates provide the structure for the summarization levels. The templates decide what fields will be grouped fields and which fields will be calculated fields. The template further defines what type of calculation will be performed for calculated fields, for example, sum, percentage, or the like.

The templates also define the necessary fields that must be in use for the template to work. As defined during the ModelHouse™ section not all available fields in the ModelHouse™ need to be used. As such the templates also define whether or not a field in the summarization is a required field. If that required field is not being used for the current installation then that template will not be used. This makes the ModelMart™ extremely flexible allowing each installation to contain data marts that only hold relevant summary level information.

### ModelScape™ Information Visualization Module

Using the data marts created by the ModelMart module the ModelScape™ Visualization Module uses reporting templates, dashboard templates and scorecard templates to create reports, dashboards and scorecards. This is based on the idea that any reporting tool can be created before any of the data that it will display is available as long as the source of the information is available and defined.

The templates are used in conjunction with rules that are defined for the source to create usable reports. The rules define every aspect of the template that it is connected with. The rules can include but are not limited to:

1. Limiting the data that will be displayed.
a. Including or excluding certain fields from the template.
b. Creating filters for the data source.
c. Changing formula values in calculated columns and\or fields.

2. Changing the name and/or descriptions used in the template.

3. Setting layout preferences

The process is designed to allow for the customization of visual tools based on templates. These templates are further defined based on rules. The ModelScape module customizes the visual tools based on rules, and in some embodiments, the ModelScape is customized during the installation of the BI system. In one embodiment, the ModelScape comprises software applications that provide reports, dashboards or KPI'S. In other embodiments, the ModelScape comprises report tools that help a user create a report. In the ModelScape the use of the templates with rules actually changes the structure of the visual tools. For example, in one embodiment, the ModelScape comprises a visual tool that defines total revenue. In one example, a template for this type of report includes but is not limited to the following fields based on information stored in one of the data marts created by the ModelMart module:

Item Qty Sale Discount Total (Calculated: (Qty×Sale)−Discount)

This visual tool is connected to a data mart with the following fields:

Item Qty Sale Discount

However, if, for example, the data source systems do not contain data relating to discounts because the company does not offer discounts, then the ModelMart will still use the data mart defined above with the exception that it would not contain the Discount field. So the data mart will only contain the following fields:

Item Qty Sale

For the visual tool to work then it cannot expect to find the Discount field because it will never contain any data and our calculated Total will be incorrect. Therefore the visual template will define what fields are necessary for it to work and what the calculated Total column should be. The following is the visual tool, as it will be created for this particular example:

Item Qty Sales Total (Calculated: Qty×Sale)

### Programming Specifications of Certain Embodiments

### ModelHouse™ Data Warehouse Module

User\Configuration Interface: The following interface and use cases outline the first step in the installation of the BI system. This form allows a user to identify the data sources for the BI system. A user can select from almost every possibly data source available from enterprise level systems like Oracle®t, Microsoft SQL Server® or IBM AS400® to flat text file extractions from point of sale systems. The ability to select any type of data source is vital to the usability of the BI system. It gives companies the ability to combine data sources from disparate systems. Another aspect of the embodiments is the process is easy to use. Once the sources are selected and verified the process does not have to be performed again. The system will save those settings and allow a user to modify those settings in the event that the data source changes or new data sources are added. This step is critical in the installation because it will determine what data will be loaded and it will allow the user to create rules around the loading of that data. In certain embodiments, the user understands the BI system data warehouse architecture such that the user can map the source data with its counter part in the BI system data warehouse. Although the user interface is written from the installation point of view the components are designed to be used in the future should any of the source data components ever change, for example, because of an upgrade to the ERP system or changing to an entirely new system.

| Interface | User\Configuration Interface |
|---|---|
| Use Cases | Set up data locations: This interface allows a user to setup or edit all of |
| | the parameters of the data sources that will be used to populate the data |
| | warehouse. |
| | System operations of this interface: Add_Location (user enters the |
| | type, name, location and any security parameters required to access the |
| | data) Edit_Location (user can change the type, name, location or |
| | security parameters of an existing data source.) Delete_Location (user |
| | can remove an existing data source) Test_Location (user can verify that |
| | a data source is still operational. The test will let the user know if there |
| | are any errors encountered) |
| | Load and select components from data locations: This interface allows |
| | the user to load all of the data components from the data locations setup |
| | in the previous step. This interface will allow the user to limit usable |
| | data components, for example, tables from a relational database. |
| | System operations: Select_Data_Source (flag a data location for |
| | loading of components) Load_Data_Source (load data source |
| | components for further selection) Select_Data_Component (flag |
| | component for loading into system) |
| | De-normalize data: This allows the user to join data components from a |
| | normalized data source and create a single flat data component that will be |
| | used to map to the BI system data warehouse. |
| | System operations: Join_Data_components (drag and drop fields from |
| | data components that will create the necessary joins between fields in |
| | the data components) Setup_Rules_components (Setup criteria for |
| | each of the fields that isolate usable data rows) |
| | Croup_Data_Components (allows fields to be grouped and or have |
| | calculations performed to further flatten data if necessary) |
| | Create_Flatten_Data Scripts (this process creates the necessary SQL |
| | scripts from the rules outlined that will be used during the load process. |
| | Note that although the scripts are created from the rules the actual script |
| | name; spFlatten_Data_Load is already part of the complete BI system |
| | ETL load process this part of the process simply clears the script body user |
| | user re-creates it based on the rules outlined.) |
| | Map data components: This interface will display and allow the user to |
| | map all of the data components selected from the previous step with the |
| | data components of BI system 1.0. This will be a one to one mapping |
| | between data components. |
| | System operations: Match_Tables (drag and drop data source |
| | components with tables from BI system data warehouse) |
| | Sub operation: Match_Fields (Once data components and tables |
| | have been matched the corresponding fields from each element are |
| | matched.) Setup Field types (For the fields matched in previous step |
| | the data type for the component is selected. Note: this is necessary |
| | because similar data fields from source components may have slight |
| | variations of data types this allows a more exact matching between data |
| | components and the fields in the BI system data warehouse. |
| | Create Relationships: This interface will display the source tables |
| | selected and will allow a user to select which fields contain matching |
| | elements, for example, a social security number for employee |
| | information or a product id for items sold. This will allow for the |
| | creation of Foreign and Primary keys in the fact and dimension tables. |
| | System operations: Select_Field (This identifies the field that contains |
| | the source field for the relationship.) Match_Field (This is the field |
| | that is being matched to the field in the Select_Field process) |
| | Validate_Match (Display the matching fields to user) |
| | Create_Foreign_Key (This process creates the foreign key in the |
| | corresponding fact or dimension table that was selected from the |
| | Match_Field process. This foreign key is a numeric value that is |
| | assigned to the value from the source data. The numeric value will then |
| | be assigned to records in the Primary key field) Create_Primary_Key |
| | (This process creates the primary key in the corresponding fact or |
| | dimension table that was selected from the Select_Field process.) |
| | Create_Constraint (This process adds the constraint in each table |
| | where there must exist an item in the table with the Primary key in |
| | order for an entry to be added in the table with the Foreign key. |
| | Create_Index (This process will create an index for the fields that |
| | make up the relationships.) |
| | Name BI system data components: This step allows the user to give the |
| | BI system Data warehouse components, tables and fields, names that |
| | are representative of the data source. One of the options will be to |
| | simply copy the name of the source elements to the corresponding BI |
| | system elements. This will help speed up the process. |
| | System operations: Copy_Names (this will copy the names of the data |
| | elements from the source data to the name component of the BI system |
| | data warehouse.) Update_Name (this process updates elements if the user |
| | chooses to manually update the names) |
| | Create BI system ModelHouse ™ data warehouse: This step actually |
| | creates the BI system data warehouse based on the selections made in |
| | the previous step. This process will take the selected table elements |
| | and create the BI system ModelHouse ™. Here the user also selects the |
| | location of the data warehouse. |
| | System operations: Create_Data_Warehouse (will create the fact and |
| | dimension tables selected above and the fields selected for the fact and |
| | dimension tables. This is a simple process by which programming code |
| | will look through all of the entries selected and then execute |
| | appropriate create commands) Create_Relationships (Based on the |
| | index fields selected this process will create relationships between the tables.) |
| | Test data loads: This last interface allows for the loading of data based |
| | on the previous setup of data sources. This allows for changes to the |
| | setup during the installation. But this interface can be used again |
| | whenever the data source changes. |
| | System operations: Load_Data (performs the necessary steps to load |
| | data from the source into the BI system data warehouse. Outline steps |
| | follow: 1. Checks for data source 2. Runs the flatten scripts that |
| | places the data in the new flattened tables 3. Runs load process that |
| | takes the data from the flattened tables and loads it to the BI system data |
| | warehouse. |

### Use of the User\Configuration Interface.

The installation and configuration use cases and their corresponding system operations work in what is commonly called a system\installation wizard. The interfaces are part of a sequence of steps that ask questions and provide placeholders and/or options for a user of the system to enter values in those placeholders or select the given options. This allows for both the validation of data and the assurance that all necessary information for the setup of the ModelHouse™ is entered. Once all of the necessary information is collected the system runs through the programming steps to create the ModelHouse™ providing a status window so that the user is aware of the progress and can take additional steps once the setup is complete. ModelMart™ Data Store Module

| Interface | Create Data Store Components |
|---|---|
| Use Cases | Create Calendar: This process creates the calendar that will be used by the |
| | data warehouse to create data marts and present date rate options to users |
| | when requesting data through any of the visualization tools. Using the Master |
| | ModelHouse ™ Calendar the user will select the time periods that are to be |
| | used. These can be hourly, daily, weekly, monthly, quarterly, yearly, or the |
| | like. The calendar will indicate when each specific time frame begins, for |
| | example, a week begins on Monday and ends on Sunday and the month is |
| | fiscal month with begin and end days that do not have to coincide with |
| | calendar months. |
| | System operations: Select_Time_Periods (The user will decide the time |
| | periods that will be included in the calendar.) Create_Calendar_Table (This |
| | process creates the table with the fields that represent the time periods |
| | selected.) Update_Begin_End_TimeFrames (This process stores inputs that |
| | define when each time period is to begin and end) Add_Calendar_Dates |
| | (This process creates the actual date entries in the calendar table based on the |
| | begin and end dates entered) |
| | Create Data Marts: This process creates summary data marts for the selected |
| | fact and dimension tables. This process uses templates that predefine |
| | relationships between the fact and dimension tables. Thus a template for the |
| | employee dimension table and the fact table will have sales aggregated by |
| | employee by day, employee by week, employee by month and any other date |
| | elements that the installation defines. These data marts will serve as the data |
| | source for all aggregate level reports, dashboards, scorecards and any other |
| | reporting tool. This process will provide the user with a list of all the data |
| | marts that the system has determined are possible given the setup options |
| | selected. The user will have the option to not create data marts. The user will |
| | also be allowed to change the default frequency of the update of the data mart. |
| | System operations: Deselect_Data_Mart (This process changes the install |
| | option from true to false for the given template. Every template that the |
| | system selects for creation is by default set to true.) Update_frequency (This |
| | process changes the default frequency for the update of the data mart. By |
| | default all data marts are updated nightly but based on the use of the data the |
| | user may change that update a number of given intervals, for example, update |
| | weekly) Create_Data_Mart (This process uses the templates to create the |
| | actual data mart table that will store the summary information.) |
| | Create OLAP Cubes: This process creates olap cubes from the created data |
| | marts. The cubes will use information from the Data Marts for analytical |
| | toolsets, for example, dashboards, kpi's and scorecards. These cubes will be |
| | grouped by dimension elements. This will allow users to quickly change the |
| | way summary data is displayed. |
| | System operations: Create OLAP Cubes |

### Use of the Create Data Store Components Interface

The Create Data Store Components use cases and their corresponding system operations work in what is commonly called a system\installation wizard. The interfaces are part of a sequence of steps that ask questions and provide placeholders and/or options for a user of the system to enter values in those placeholders or select the given options. This allows for both the validation of data and the assurance that all necessary information for the setup of the ModelScape™ is entered. Once all of the necessary information is collected the system runs through the programming steps to create the data marts providing a status window so that the user is aware of the progress and can take additional steps once the setup is complete.

### ModelScape™ Information Visualization Module

| Interface | Create Visualization Components |
|---|---|
| Use Cases | Create visualization components: This process creates the defined |
| | visual components. This process runs as part of the installation of the |
| | system and the user of the system is not asked any questions but is |
| | given a status indicating that BI system ModelScape ™ is being |
| | installed. The following system operations are executed and are what creates |
| | the visual components. |
| | System operations: Identifiy_Visual_Components_Usability (System |
| | will go through all of the visual components and identify whether the |
| | visual component will be used. This is determined by identifying |
| | whether or not the source component, a data mart or OLAP cube, were |
| | created during the installation.) Evaluate_Usability (Once the visual |
| | tools source has been confirmed the usability of the visual tool itself is |
| | determined by looking at the rules assigned to the template. For |
| | example in order for the visual tool to be created there will have to be a |
| | minimum number of fields created in the source data.) |
| | Create_Visual_Tool (This process actually creates the visual |
| | component.) Add_Visual_Tool_To_Directory (This process adds the meta |
| | visual tool to the Tool Directory. The Tool Directory is part of the |
| | data warehouse.) |

Use of the Create Visualization Components interface

The Create Visualization Components use cases and their corresponding system operations work in what is commonly called a system\installation wizard. The interfaces are part of a sequence of steps that ask questions and provide placeholders and/or options for a user of the system to enter values in those placeholders or select the given options. This allows for both the validation of data and the assurance that all necessary information for the setup of the ModelScape™ is entered. Once all of the necessary information is collected the system runs through the programming steps to create the data marts providing a status window so that the user is aware of the progress and can take additional steps once the setup is complete.

In some embodiments, it is contemplated that some or all of the steps described herein may be implemented within, or using, software modules (programs) that are executed by one or more general purpose computers. In these embodiments, the software modules may be stored on or within any suitable computer-readable medium. It should be understood that the various steps may alternatively be implemented in-whole or in-part within specially designed hardware.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

### System Information

In one embodiment, the systems and methods for providing business intelligence may be embodied in part or in whole in software that is running on a computing device. The functionality provided for in the components and modules of the computing device may comprise one or more components and/or modules. For example, the computing device may comprise multiple central processing units (CPUs) and a mass storage device, such as may be implemented in an array of servers.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, Lua, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, the computing device communicates with one or more databases that store information, including credit data and/or non-credit data. This database or databases may be implemented using a relational database, such as Sybase, Oracle, CodeBase and Microsoft® SQL Server as well as other types of databases such as, for example, a flat file database, an entity-relationship database, and object-oriented database, and/or a record-based database.

In one embodiment, the computing device is IBM, Macintosh, or Linux/Unix compatible. In another embodiment, the computing device comprises a server, a laptop computer, a cell phone, a personal digital assistant, a kiosk, or an audio player, for example. In one embodiment, the computing device includes but is not limited to one or more CPUs, which may each include microprocessors. The computing device may further include one or more memory devices, such as random access memory (RAM) for temporary storage of information and read only memory (ROM) for permanent storage of information, and one or more mass storage devices, such as hard drives, diskettes, or optical media storage devices. In one embodiment, the modules of the computing are in communication via a standards based bus system, such as bus systems using Peripheral Component Interconnect (PCI), Microchannel, SCSI, Industrial Standard Architecture (ISA) and Extended ISA (EISA) architectures, for example. In certain embodiments, components of the computing device communicate via a network, such as a local area network that may be secured.

The computing is generally controlled and coordinated by operating system software, such as the Windows 95, Windows 98, Windows NT, Windows 2000, Windows XP, Windows Vista, Linux, SunOS, Solaris, PalmOS, Blackberry OS, or other compatible operating systems. In Macintosh systems, the operating system may be any available operating system, such as MAC OS X. In other embodiments, the computing device may be controlled by a proprietary operating system. Conventional operating systems control and schedule computer processes for execution, perform memory management, provide file system, networking, and I/O services, and provide a user interface, such as a graphical user interface (“GUI”), among other things.

The computing device may include one or more commonly available input/output (I/O) devices and interfaces, such as a keyboard, mouse, touchpad, microphone, and printer. Thus, in one embodiment the computing device may be controlled using the keyboard and mouse input devices, while in another embodiment the user may provide voice commands to the computing device via a microphone. In one embodiment, the I/O devices and interfaces include one or more display device, such as a monitor, that allows the visual presentation of data to a user. More particularly, a display device provides for the presentation of GUIs, application software data, and multimedia presentations, for example. The computing device may also include one or more multimedia devices, such as speakers, video cards, graphics accelerators, and microphones, for example.

In one embodiment, the I/O devices and interfaces provide a communication interface to various external devices. For example, the computing device may be configured to communicate with one or more networks, such as any combination of one or more LANs, WANs, a virtual private network (VPN), or the Internet, for example, via a wired, wireless, or combination of wired and wireless, communication links. The network communicates with various computing devices and/or other electronic devices via wired or wireless communication links.

In some embodiments, the acts, methods, and processes described herein are implemented within, or using, software modules (programs) that are executed by one or more general purpose computers. The software modules may be stored on or within any suitable computer-readable medium. It should be understood that the various steps may alternatively be implemented in-whole or in-part within specially designed hardware. The skilled artisan will recognize that not all calculations, analyses and/or optimization require the use of computers, though any of the above-described methods, calculations or analyses can be facilitated through the use of computers.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Thus, it is intended that the scope of the present invention herein disclosed should not be limited by the particular disclosed embodiments described above.

What is claimed is:

1. A computer implemented business intelligence system comprising:
a database system having pre-existing fact tables wherein the fact tables comprise a plurality of fact table elements and a plurality of relationships linking the fact tables and the plurality of fact table elements;
the database further comprises a wizard module configured to allow a user to match data elements from a plurality of data sources to the plurality of fact table elements in the fact tables;
wherein the wizard module is further configured to establish data relationships between the data elements from the plurality of data sources based on the plurality of relationships linking the fact tables and the plurality of fact table elements;
a data mart module having pre-established rules or templates for creating sets of summary level repositories based on the user matching of data elements from a plurality of data sources to the plurality of fact table elements in the fact tables; and
a visualization module having pre-established visual reporting tools, wherein the visualization module is configured to determine which visual reporting tools to use based on the user matching of data elements from a plurality of data sources to the plurality of fact table elements in the fact tables.

2. The business intelligence system, wherein the reporting tools comprise dashboards or scorecards.
